(19) United States
(12) Patent Application Publication
(10) Pub. No.: US 2004/0177157 A1
(43) Pub. Date: Sep. 9, 2004

(54) Logical grouping of VPN tunnels

(75) Inventors: Nalin Mistry, Nepean (CA); Abdulkadev Barbir, Nepean (CA); Wayne Ding, Kanata (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 10/659,284

(22) Filed: Sep. 11, 2003

Related U.S. Application Data
(60) Provisional application No. 60/446,989, filed on Feb. 13, 2003.

(51) Int. Cl. G06F 15/173; G06F 15/16

(52) U.S. Cl. 709/241; 709/245

(57) ABSTRACT

Virtual Private Network (VPN) tunnels through a backbone network operated by a service provider may be considered as a logical grouping where the VPN tunnels share certain characteristics. The forwarding of a received packet onto a particular one of these VPN tunnels may be determined through a cascade of lookup tables. According to satisfaction of classification criteria, a given received packet may be modified for special treatment within the backbone network.

### CROSS REFERENCE TO RELATED APPLICATIONS

The present application claims the benefit of prior provisional application serial No. 60/446,989, filed Feb. 13, 2003.

### FIELD OF THE INVENTION

The present invention relates to Virtual Private Networks (VPNs) and, more particularly, to the logical grouping of VPN tunnels.

### BACKGROUND

Traditionally, to securely connect geographically distributed private local area networks (LANs) of an enterprise to each other, hard-wired connections were leased from telecommunication companies, or at least an amount of guaranteed bandwidth on these connections. As well, to connect a single remote user to a private LAN, the remote user would dial in to a dedicated collection of modems, phone lines and associated network access servers. These private LANs are typically used for networking functions (e.g., e-mail, file sharing, printing) within an enterprise. Network connected devices within such a private LAN are not intended to be reachable by devices in other, unrelated networks. Increasingly, the use of Virtual Private Networks (VPNs) is replacing the use of leased hard-wired connections for providing links between LANs and the use of dedicated dial-up lines for providing remote users access to corporate intranets.

VPN technology enables secure, private connections between geographically remote sites over a shared network (shared “backbone”). VPN technology may be used to implement a corporate intranet/extranet, to promote use of remote offices and/or to provide mobility to workers. Additionally, using VPN technology, services may be extended to multiple communities of interest.

At least three functional types of routers may be defined to comprise a VPN. Customer edge (CE) routers sit at the customer site and are typically owned by the customer. However, some service providers provide equipment for CE routers. CE routers are connected to provider edge (PE) routers. PE routers are typically owned by service providers and serve as the entry points into the backbone network of the service provider. Finally, provider (P) routers are defined as transit routers within the backbone network. Physical links connect PE routers to P routers and P routers to other P routers.

To provide a VPN service to a customer, a service provider may set up one or more tunnels between a first PE router to a second PE router. Tunneling involves the encapsulation of a sender's data in packets. These encapsulated packets hide the underlying routing and switching infrastructure of the backbone network from both senders and receivers. At the same time, these encapsulated packets can be protected against snooping by outsiders through the use of encryption techniques. These tunnels may be made up of one or more physical links, yet, to the customer, it appears as though the first PE router is connected directly to the second PE router, i.e., the connection appears to be a single hop.

As service providers provide VPN services to an increasing number of customers, the associated VPN Routing and Forwarding Tables can become large and the distribution of these tables to particular nodes in the service provider's network may become unduly burdensome.

### SUMMARY

Several VPN tunnels may be logically grouped with each other based on characteristics of the VPN tunnels. Logical groupings may further be partitioned to logical sub-groupings. Additionally, logical groupings may be defined for VPN tunnels between adjacent nodes or for VPN tunnels that span multiple nodes. A logical grouping including several VPN tunnels, each including multiple physical links, may appear to the customer as a single hop.

In accordance with an aspect of the present invention there is provided a method of forwarding a packet. The method includes determining a logical grouping of a plurality of virtual private network tunnels based on a classification criterion, classifying a received packet based on the classification criterion and based on a result of the classifying, using a selection algorithm associated with the logical grouping to determine one of the plurality of virtual private network tunnels on which to forward the packet. In other aspects of the invention, a router is provided operable to carry out this method and a computer readable medium is provided to allow a general purpose computer to carry out this method.

In accordance with another aspect of the present invention there is provided a method of forwarding a received packet in a virtual private network. The method includes associating a logical grouping of a plurality of virtual private network tunnels with a classification criterion, inspecting the received packet for a characteristic meeting the classification criterion and, if the received packet has the characteristic meeting the classification criterion, forwarding the received packet on one of the plurality of virtual private network tunnels. In another aspect of the invention, a router is provided operable to carry out this method.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 illustrates an exemplary network including a backbone network and several customer sites;

FIG. 2 illustrates the backbone network of FIG. 1 in greater detail;

FIG. 3 illustrates an exemplary VPN Routing and Forwarding Table;

FIG. 4 illustrates an exemplary IGP routing table;

FIG. 5 illustrates the backbone network of FIG. 2 with exemplary VPN tunnels identified;

FIG. 6 illustrates an exemplary logical group ID table according to an embodiment of the present invention;

FIG. 7 illustrates an exemplary VPN Routing and Forwarding Table and an exemplary IGP routing table, where the tables are associated with a first logical grouping of VPN tunnels according to an embodiment of the present invention;

FIG. 8 illustrates an exemplary sub-logical group ID table according to an embodiment of the present invention;

FIG. 9 illustrates an exemplary VPN Routing and Forwarding Table and an exemplary IGP routing table, where the tables are associated with a second logical grouping of VPN tunnels according to an embodiment of the present invention; and

FIG. 10 illustrates an exemplary VPN Routing and Forwarding Table and an exemplary IGP routing table, where the tables are associated with a third logical grouping of VPN tunnels according to an embodiment of the present invention.

### DETAILED DESCRIPTION

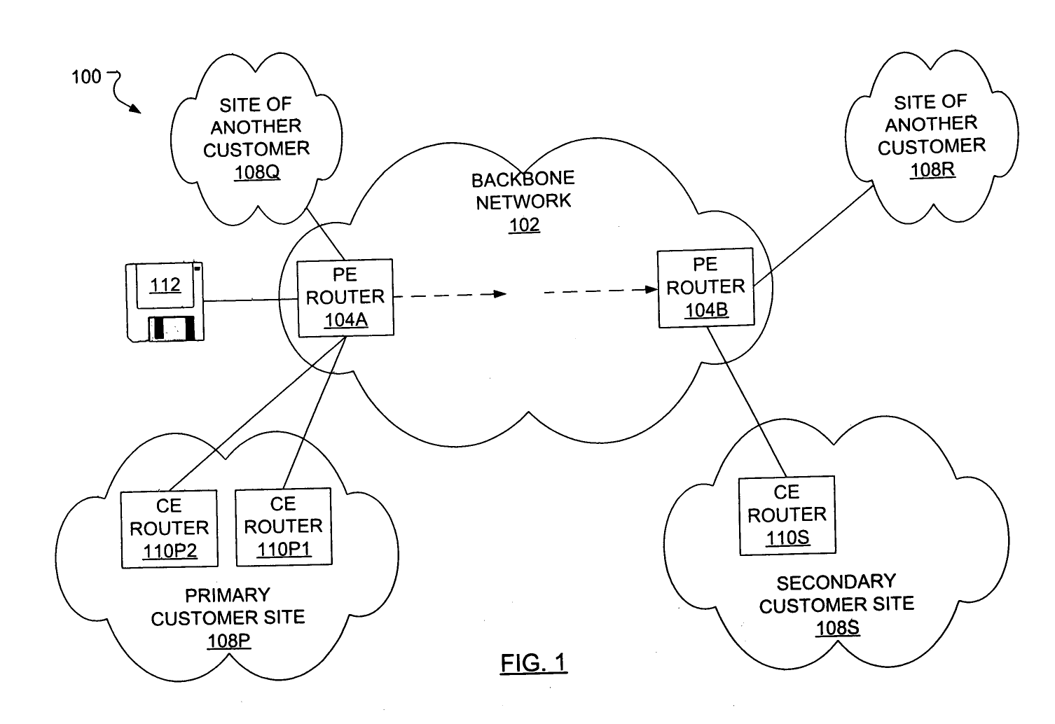

A simplified network 100 is illustrated in FIG. 1 wherein a backbone network 102 is used by a service provider to connect a primary customer site 108P to a secondary customer site 108S (collectively or individually 108). The backbone network 102 of the service provider may also be used to connect customer sites 108Q, 108R of other customers. A first CE router 110P1 and a second CE router 110P2 at the primary customer site 108P are connected to a first PE router 104A in the backbone network 102. Further, a third CE router 110S, at the secondary customer site 108S, is connected to a second PE router 104B in the backbone network 102. (PE routers may be referred to individually or collectively as 104. Similarly, CE routers may be referred to individually or collectively as 110). The customer contracts with the service provider to provide one or more VPN tunnels between the first PE router 104A and the second PE router 104B. Each such tunnel may have particular Quality of Service (QoS) characteristics, such as speed of data transfer or delay.

The PE router 108A may be loaded with logical grouping software for executing methods exemplary of this invention from a software medium 112 which could be a disk, a tape, a chip or a random access memory containing a file downloaded from a remote source.

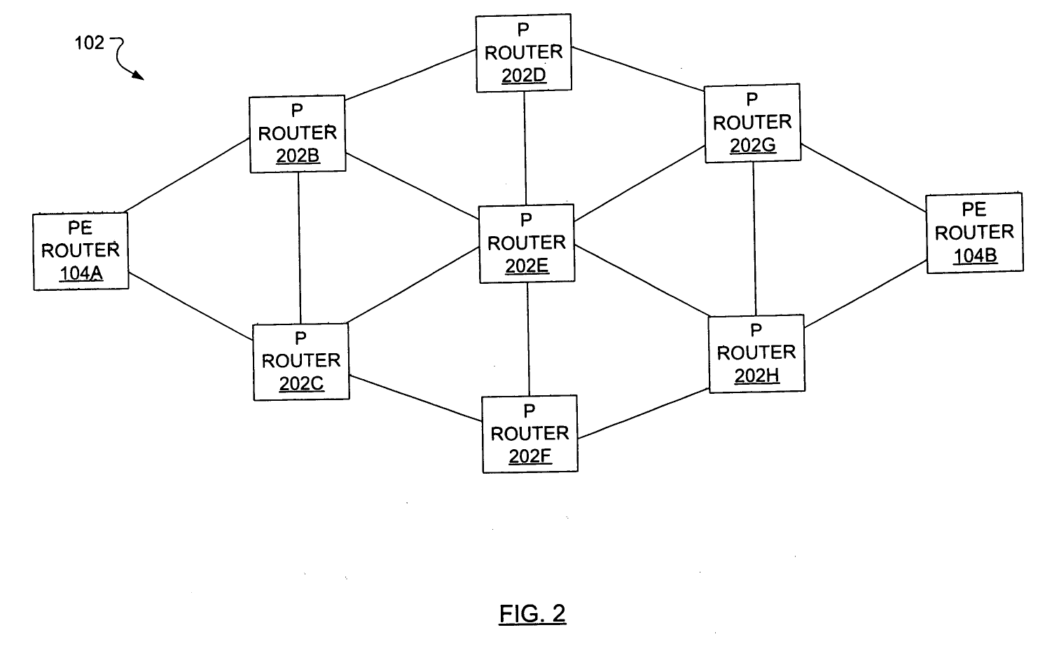

The content of the backbone network 102 of FIG. 1 is illustrated in further detail in FIG. 2. In particular, the backbone network 102 is illustrated to include a plurality of interconnected P routers 202B, 202C, 202D, 202E, 202F, 202G, 202H (individually or collectively 202). The P routers 202 are also interconnected with the PE routers 104. The links between the various. routers 104, 202 may be electronic, optical or wireless. An optical link between routers may be, for example, an OC3 link employing the known SONET (Synchronous Optical NETwork) standard. Note that the P routers 202 may connect to neighboring routers 104, 202 using more than one physical link and that the links are understood to be made up of two unidirectional links carrying traffic in opposite directions.

Protocols that have been defined and have been useful in the development of VPNs include the known Border Gateway Protocol (BGP), the Interior Gateway Protocol (IGP) and Multi Protocol Label Switching (MPLS).

A particular implementation of VPNs is described in E. Rosen, et al., “BGP/MPLS VPNs”, Internet Engineering Task Force (IETF) Request for Comments (RFC) 2547, hereby incorporated herein by reference, which specifies using a peer-to-peer model, in which routing information is exchanged using BGP: between a CE router and a PE router; from one PE router to another PE router within the network of a single service provider; or between P routers.

In BGP/MPLS based VPNs, the service provider is responsible for establishing paths through a backbone network and propagating routing information to customer sites. Security and privacy is achieved by limiting the distribution of the routing information specific to a given VPN only to members of the given VPN. That is, information about routes to VPN sites is only advertised to members of the given VPN and is not shared with devices outside the given VPN.

MPLS is based upon routers, or switches, performing label switching to provide a Label Switched Path (LSP) through a network. Essentially, when an IP packet enters an interface of an MPLS ingress router, that router assigns the packet to a Forwarding Equivalency Class (FEC).

The labels used in MPLS have only local significance. Intervening Label Switch Routers (LSRs) “swap” the label on an incoming packet for a label defined in the MPLS forwarding database particular to the LSR. When the MPLS egress, or final, router is reached, the label is permanently removed, or “popped”, prior to the egress router forwarding the regular IP packet.

MPLS may be used to forward packets over a network backbone and BGP may be used to distribute routing information. Routing information may be passed between a CE router 110 and the PE router 104, to which the CE router 110 is directly connected, using IGP, BGP or through default routes defined on each router in the VPN. Each PE router 104 may maintain one or more per-site forwarding tables known as VPN Routing and Forwarding Tables (VRFs). Within a given PE router 104, each VRF serves a particular interface, or set of interfaces, that belong to each individual VPN. That is, for each VPN to which a given PE router 104 belongs, the PE router 104 has a corresponding VRF.

In order to support overlapping address spaces, BGP/MPLS based VPNs utilize the VPN-IPv4 (VPN-Internet Protocol version 4) address family combined with multi-protocol extensions to BGP. A VPN-IPv4 address is a 12 byte address that begins with eight byte Route Distinguisher (RD) and ends with a four byte IPv4 address. It is the task of PE routers 104 to translate IPv4 addresses into unique VPN-IPv4 addresses. This ensures that if a given IPv4 address is used in two different VPNs, it is possible that two different routes to the given IPv4 address may be stored in appropriate VPN Routing and Forwarding Tables, one route for each VPN.

There are two control mechanisms within BGP/MPLS VPNs. The first control mechanism is used for the exchange of routing information between different PE routers that make up a VPN. The second control mechanism is used for the establishment of LSPs across a service provider backbone network.

In the first control mechanism, the PE routers 104 learn customer routes from CE routers 110. These routes may be learned through the use of an IGP, BGP or through static configuration on the PE router.

In the second control mechanism, LSP establishment for VPN tunnels may be accomplished through the known Label Distribution Protocol (LDP) or Resource reSerVation Protocol (RSVP), for instance. A service provider would use LDP when there is a need to establish best effort routing between PE routers 104 using a particular IGP. However, if there is a need for the service provider to assign bandwidth requirements, other constraints, or offer advanced services, RSVP may be seen as a better choice to signal LSP path.

The following description of a method of forwarding packets across the backbone is adapted from RFC 2547, which was incorporated by reference hereinbefore.

Even though the intermediate P routers 202 in the backbone 102 do not have any information about routes associated with the VPNs, packets are forwarded from one VPN site (customer site 108) to another using MPLS with a two-level label stack.

The PE routers 104 may insert address prefixes for themselves into the IGP routing tables of the P routers 202 of the backbone network 102. These address prefixes enable the MPLS process at each P router 202 to assign a label corresponding to the route to each PE router 104. Notably, certain procedures for setting up label switched paths in the backbone network 102 may not require the presence of these address prefixes.

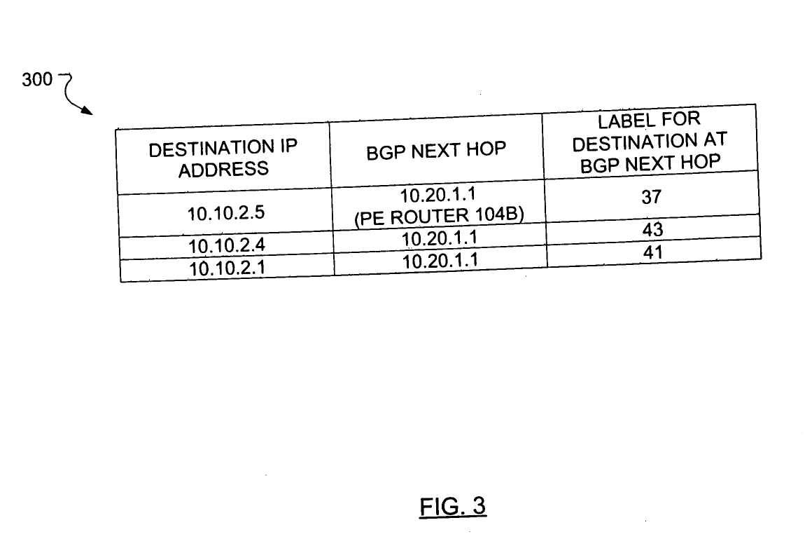

Consider a scenario wherein the first PE router 104A receives an IP packet from the first CE device 110P1 in the primary customer site 108P. The IP packet is understood to include a standard IP header as well as payload. Such an IP header typically includes such information as a source IP address and a destination IP address. The first PE router 104A initially selects a VRF particular to the VPN (typically identified in the packet by a VPN ID) and uses the destination address of the packet as a lookup key for the VRF. FIG. 3 illustrates an exemplary VRF 300. Put another way, the first PE router 104A identifies a classification criteria of the received packet, where, in this case, the classification criteria is the VPN identified by the VPN ID in the packet.

If the packet is destined for the second CE router 110P2 in the primary customer site 108P attached to the first PE router 104A, the packet is sent directly to the second CE router 110P2.

If the packet is not destined for a CE device attached to the first PE router 104A, a “BGP next hop” (i.e., the appropriate PE attached to the destination CE, e.g., the second PE router 104B) of the packet is found in the VRF, as well as the label that has been assigned, at the BGP next hop, to the destination address of the packet. In the exemplary VRF 300 (FIG. 3), the destination IP address 10.10.2.5 may be used as a lookup key to determine a BGP next hop (it is assumed that the IP address of the second PE router 104B is 10.20.1.1) and a label (37) assigned at the BGP next hop to the destination IP address 10.10.2.5. (Note that, despite the fact that we are using IP-style addresses in this example, the present invention is not limited to an IP implementation.)

It may be considered that the use of a VRF constitutes the performance of a selection algorithm. Where the result of the performance of the selection algorithm is information to be used when forwarding the packet. The information that may be learned from the exemplary VRF 300 and used when forwarding the packet includes an address for the destination PE router and a label to identify the destination CE router to the destination PE router.

Consider, for instance, that the packet is destined for the third CE router 110S attached to the second PE router 104B.

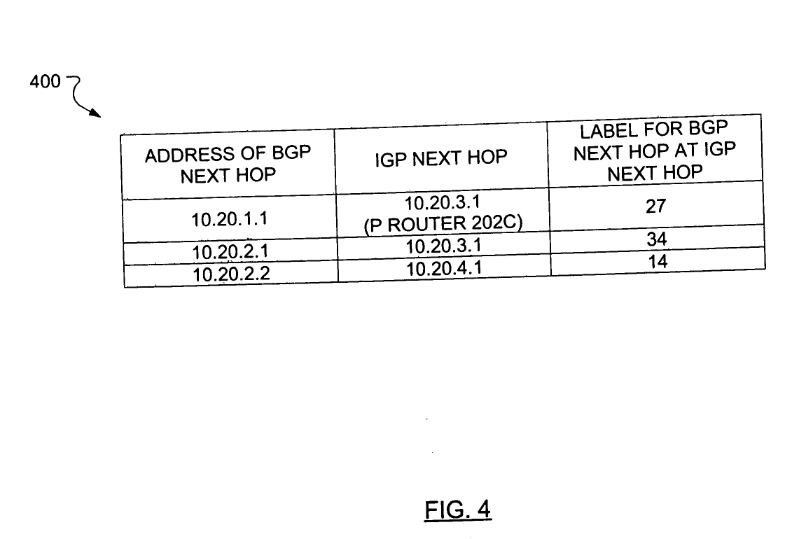

The label associated with the destination of the packet (the third CE router 110S) by the BGP next hop (the second PE router 104B) is pushed onto the MPLS label stack of the packet, by the first PE router 104A, and becomes the bottom label. The first PE router 104A then uses the BGP next hop as a key to lookup, in an IGP routing table 400 (FIG. 4), an IGP route to the BGP next hop. The IGP allows navigation through the network 102 to the boundary PE attached to the destination CE. The IGP routing table 400 provides the first PE router 104A with an identity for an IGP next hop (e.g., the P router 202C). From the same table, the first PE router 104A learns the label assigned to the address of the BGP next hop (the second PE router 104B) by the IGP next hop (the P router 202C) according to a given label switched path. This label gets pushed onto the MPLS label stack of the packet, and becomes the top label, and the packet is then forwarded to the IGP next hop. In a special case, the BGP next hop is the same as the IGP next hop, and the label assigned to the address of the BGP next hop may not need to be pushed onto the MPLS label stack of the packet.

At this point, the P routers 202 use MPLS to carry the packet across the backbone network 102 and to the third CE router 110S. That is, all forwarding decisions by P routers 202 and PE routers 104 are now made by an MPLS process. To continue the example, the P router 202C reads the top label of the MPLS stack and, from a forwarding table, the P router 202C determines the IGP next hop—i.e., the next P router to which to forward the packet—(say, the P router 202E) and learns the label associated with that destination. This label gets pushed onto the MPLS label stack of the packet, and becomes the top label, and the packet is then forwarded to the IGP next hop. The label stack associated with the IP packet is distinct from the IP header. The IP header of the packet is not looked at again until the packet reaches the third CE router 110S. Upon receiving the packet, the second PE router 104B “pops” the bottom label out of the MPLS label stack of the packet before sending the packet to the third CE router 110S, thus the third CE router 110S simply sees an ordinary IP packet.

In review, in the known BGP/MPLS based implementation of VPNs, when a packet identifying a particular VPN enters the backbone network 102 at a given PE router, the route of the packet through the backbone network 102 is determined by the contents of the forwarding table that the given PE router has associated with the particular VPN. The forwarding tables of the PE router where the packet leaves the backbone network 102 are not used.

Note that it is the two-level labeling that makes it possible to keep all the VPN routing information out of the P routers 202 and this, in turn, is crucial to ensuring the scalability of the model. The P routers 202 of the backbone network 102 need not maintain information on routes to the CE routers 110, the P routers 202 need only maintain information on routes to the PE routers 104.

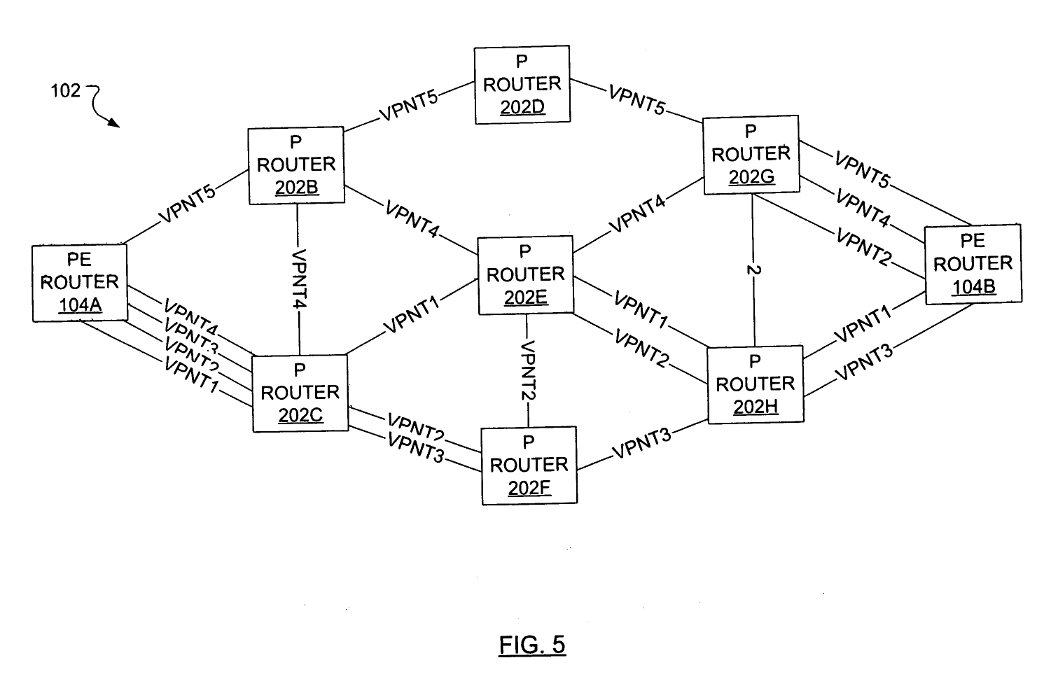

Notably, a given routing table may not associate only a single IGP route to a given BGP next hop. There may, in fact, be multiple label switched paths (LSPs) between the PE router of interest and the given BGP next hop. Each of these LSPs may be considered, in the context of BGP/MPLS based VPNs, a VPN tunnel. The detail of the backbone network 102, first illustrated in FIG. 2, is illustrated again in FIG. 5, showing five LSPs, or VPN tunnels, from the first PE router 104A to the second PE router 104B.

In particular, the five VPN tunnels include: a VPN tunnel identified as VPNT1 that passes through the P routers C, E and H; a VPN tunnel identified as VPNT2 that passes through the P routers C, F, E and H; a VPN tunnel identified as VPNT3 that passes through the P routers C, F and H; a VPN tunnel identified as VPNT4 that passes through the P routers C, B, E and G; and a VPN tunnel identified as VPNT5 that passes through the P routers B, D and G. It may be advantageous to consider the VPN tunnels that have common characteristics to be logically grouped. For instance, one logical grouping (logical group ID=700) may include VPNT1, VPNT3 and VPNT5 because these VPN tunnels each have only four hops. Another logical grouping (logical group ID=800) may include all five VPN tunnels and be based on available bandwidth.

Returning to the example described above, it may be recognized that the label switched path taken by the packet corresponds to the VPN tunnel identified as VPNT1. By selecting a particular label for the BGP next hop (the second PE router 104B), the first PE router 104A selected the VPN tunnel identified as VPNT1. As indicated in the VRF 300 (FIG. 3), other labels are associated with the same BGP next hop. By selecting another label, another label switched path, and thus another VPN tunnel, is selected.

In overview, based on classification criteria identified in a packet received from the first CE router 110P1, the first PE router 104A may select a logical grouping of VPN tunnels, rather than selecting a single VPN tunnel through which to forward a packet. Further sub-groupings of the selected logical grouping of VPN tunnels may be selected based on further packet characteristics. Eventually, a single VPN tunnel through which to forward a packet may be selected, and the packet may then be forwarded in a traditional manner. As will be apparent upon review of the following, the classification criteria may be widely varied, rather than being limited to a VPN-specific model. With reference to the commonly-referenced multi-layered communication model, Open Systems Interconnection (OSI), the classification criteria may include: layer 1 criteria, for instance, input port; layer 2 criteria, for instance, a VPN group identifier; layer 3 criteria, for instance, source Internet protocol (IP) address and/or destination IP address; and layer 7 criteria, for instance, an indication that the packet is carrying Hypertext Transport Protocol (HTTP) traffic.

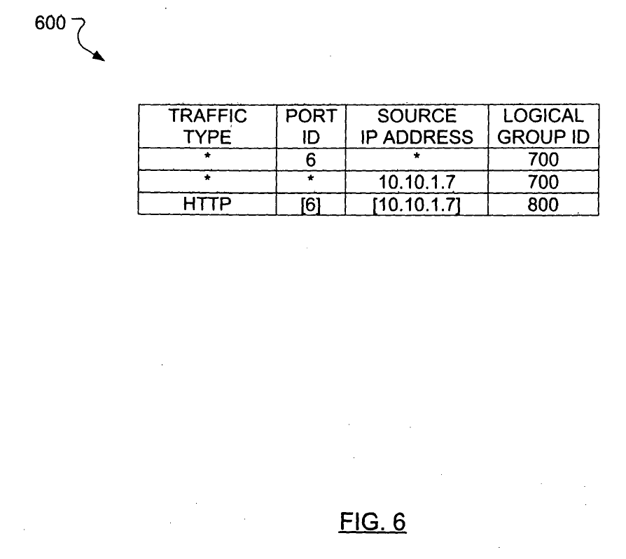

The initial table lookup performed by the first PE router 104A then, upon receipt of a packet, may be in a table such as the logical group ID table 600 illustrated in FIG. 6. The logical group ID table 600 associates classification criteria of the received packet with a logical grouping of VPN tunnels. A VRF (VPN Routing and Forwarding Table) may then be associated with each logical grouping. Optionally, a sub-logical group ID table may allow further differentiation of packets based on further classification criteria.

The classification criteria associated in the logical group ID table 600 with various logical groupings of VPN tunnels includes an indication of traffic type, an identifier of the interface (i.e., the port) on which a given packet is received and the source IP address of the packet. In particular, those packets received on port 6 or having a source IP address of 10.10.1.7 are associated with the logical grouping that has a logical group ID of 700. Recall that VPNT1, VPNT3 and VPNT5 make up the logical grouping with the logical group ID of 700 because these VPN tunnels each have only four hops. It may be that the customer prefers traffic from the identified port or source IP address to use minimum-hop-count VPN tunnels.

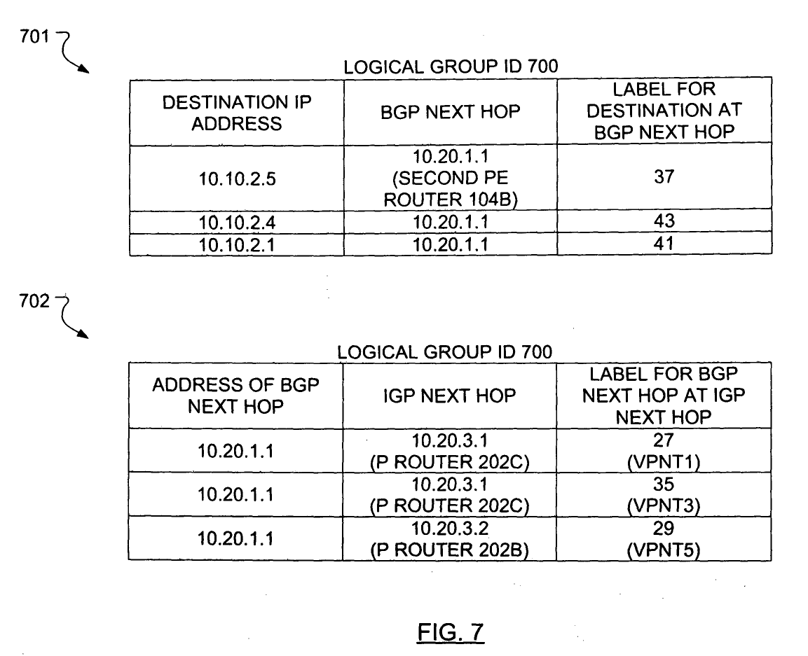

If, for example, the request for minimum-hop-count tunnels is the only restriction placed on this traffic, the first PE router 104A, upon receiving a packet having these characteristics may be directed by the logical group ID table 600 to a VRF 701 (FIG. 7) associated with the logical grouping of VPNs that has the logical group ID of 700. The logical group 700 VRF 701 associates a destination IP address with a label that may be used by the BGP next hop (i.e., at the second PE rout r 104B) to identify a network element having the destination IP address.

The first PE router 104A then uses the BGP next hop as a key to lookup, in a logical group 700 IGP routing table 702, an IGP route to the BGP next hop. The logical group 700 IGP routing table 702 provides the first PE router 104A with an identity for an IGP next hop. From the same table, the first PE router 104A learns the label assigned to the address of the BGP next hop (the second PE router 104B) by the IGP next hop according to an associated label switched path. As shown in FIG. 7, the logical group 700 IGP routing table 702 provides two choices of IGP next hop and, overall, three choices of label for the BGP next hop at the IGP next hop. Each of the three label choices corresponds to one of the three VPN tunnels that make up the logical group 700.

The VPN tunnel selected from the three choices may be selected according to some traffic balancing algorithm. For instance, each packet to be sent over the logical group 700 VPN tunnels may be sent over a different tunnel in a rotating format (VPNT1, VPNT3, VPNT5, VPNT1, . . . , etc.). Alternatively, all packets identified as being part of a particular flow may use the same VPN tunnel and the rotating use of these three VPN tunnels may rotate with each new flow. Such balancing algorithms may be chosen to provide a particular degree of traffic distribution between the three VPN tunnels in the logical grouping.

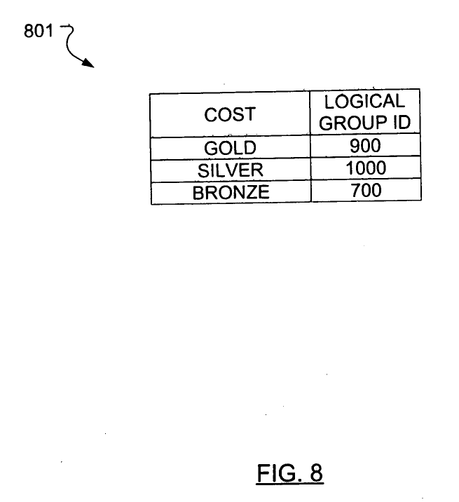

Returning to the logical group ID table 600 of FIG. 6, it may be seen that those packets received whose traffic type is HTTP are associated with the logical grouping that has a logical group ID of 800. Recall that all five VPN tunnels make up the logical grouping with the logical group ID of 800 because each of the VPN tunnels meets a minimum bandwidth criterion. However, there may be further criteria against which the packets may be judged. As such, the first PE router 104A, upon receiving a packet having these characteristics may be directed by the logical group ID table 600 to a sub-logical group ID table 801 (FIG. 8) by virtue of an association of the logical group ID of 800 with table 801.

The sub-logical group ID table 801 associates a classification criteria of “cost” with a logical group ID. Each of the links that make up a label switched path over which a VPN tunnel may be defined has an associated cost to the service provider and, perhaps corresponding to the cost will be other characteristics such as delay. A customer of the service provider may be willing to pay a premium for certain traffic to be carried on the higher cost VPN tunnels. In such a case, the customer may mark packets with an indication of the level of cost that may be borne in the transfer of the marked packet. These levels may be, for instance, gold, silver and bronze.

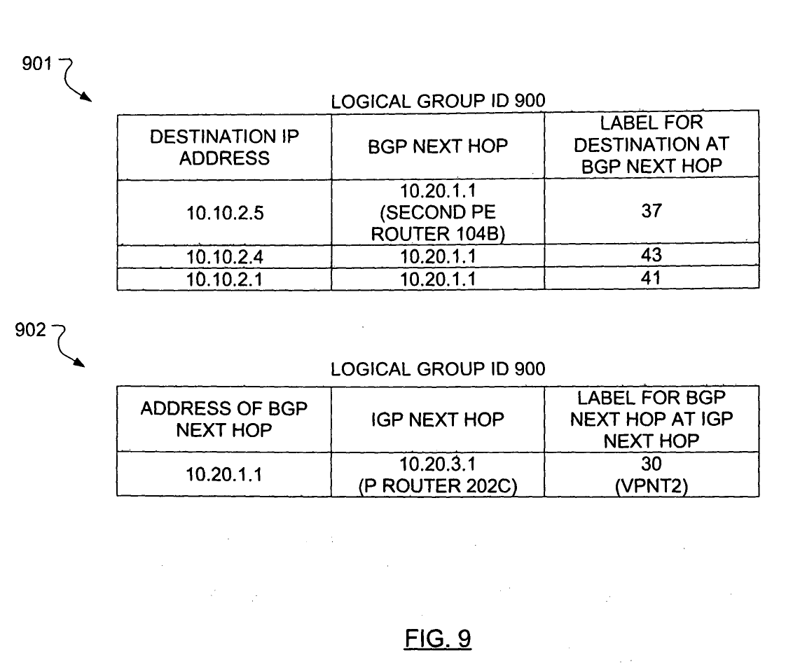

In FIG. 8, it may be seen that gold traffic is to be associated with the logical grouping that has the logical group ID of 900. The first PE router 104A, upon receiving a packet marked as gold may be directed by the sub-logical group ID table 800 to a VRF 901 (FIG. 9) associated with the logical grouping that has the logical group ID of 900. The logical group 900 VRF 901 associates destination IP addresses with labels that are used by the BGP next hop (i.e., at the second PE router 104B) to identify the same network elements.

The first PE router 104A then uses the BGP next hop as a key to lookup, in a logical group 900 IGP routing table 902, an IGP route to the BGP next hop. The logical group 900 IGP routing table 902 provides the first PE router 104A with an identity for an IGP next hop. From the same table, the first PE router 104A learns the label assigned to the address of the BGP next hop (the second PE router 104B) by the IGP next hop according to an associated label switched path. As shown in FIG. 9, the logical group 900 IGP routing table 902 provides only one choice of IGP next hop. The single choice corresponds to the VPN tunnel VPNT2.

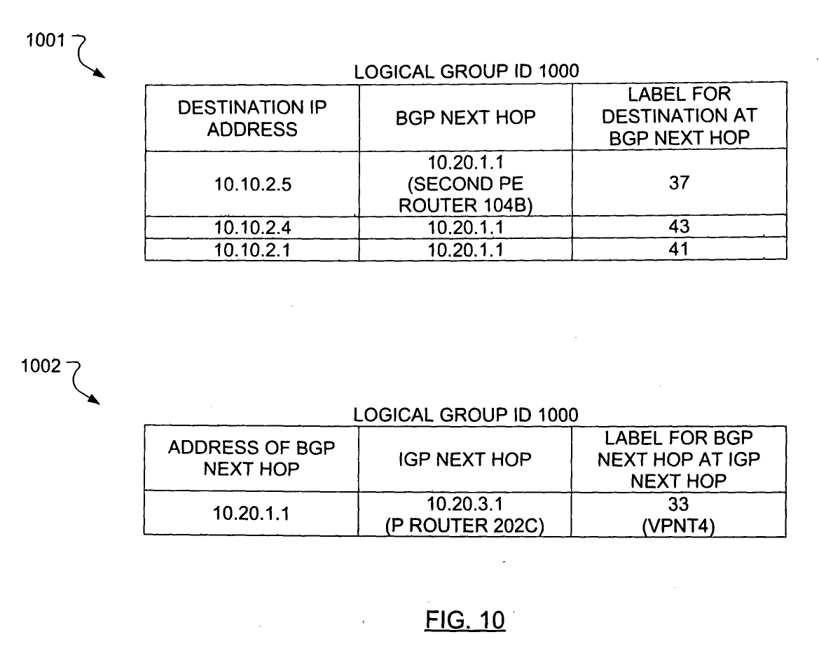

Returning to FIG. 8, it may be seen that silver traffic is to be associated with the logical grouping that has the logical group ID of 1000. The first PE router 104A, upon receiving a packet marked as silver may be directed by the sub-logical group ID table 800 to a VRF 1001 (FIG. 10) associated with the logical grouping that has the logical group ID of 1000. The logical group 1000 VRF 1001 associates destination IP addresses with labels that are used by the BGP next hop (i.e., at the second PE router 104B) to identify the same network elements.

The first PE router 104A then uses the BGP next hop as a key to lookup, in a logical group 1000 IGP routing table 1002, an IGP route to the BGP next hop. The logical group 1000 IGP routing table 1002 provides the first PE router 104A with an identity for an IGP next hop. From the same table, the first PE router 104A learns the label assigned to the address of the BGP next hop (the second PE router 104B) by the IGP next hop according to an associated label switched path. As shown in FIG. 10, the logical group 1000 IGP routing table 1002 provides only one choice of IGP next hop. The single choice corresponds to the VPN tunnel VPNT4.

Returning to FIG. 8 once more, it may be seen that bronze traffic is to be associated with the logical grouping that has the logical group ID of 700. The first PE router 104A, upon receiving a packet marked as bronze may be directed by the sub-logical group ID table 800 to the logical group 700 VRF 701 that has been discussed hereinbefore and a VPN may be selected based on load balancing.

The use of the logical groupings of VPN tunnels may not be limited to merely inspecting packet contents. Once a packet is identified as having a given classification criterion, the packet may be modified. Wired Ethernet includes support for Quality of Service (QoS) in the form of 802.1p packet tagging based on the IEEE 802.1D specification, which defines the addition of four bytes to the legacy Ethernet frame format. The defined priority tagging mechanism is known as IEEE 802.1p priority tagging, and it allows for eight levels of priority.

It may be then, that traffic units arrive at a PE router with eight levels of priority. It may also be that the traffic units depart the PE router with eight levels of priority. However, the levels may not map directly. For instance, if three of eight levels of priority at the output of the PE router are reserved for some reason, the eight levels of priority of the incoming traffic units must be mapped to the remaining five levels of priority available in the PE router. By appropriately configuring the logical groupings, a mapping to a particular one of the available levels of priority may be targeted to incoming packets having, for instance, one of two levels of priority.

Packet modification may also be extended to include packet encapsulation. For instance, a customer may require an additional level of security for packets originating at a specific address. An appropriately configured logical group ID table may select packets from that specific address for security encapsulation.

Although it may not be clear from the foregoing examples, it should be apparent to a person skilled in the art that the formation of logical groupings of VPN tunnels provides an opportunity to greatly simplify routing tables. Rather that a single large routing table covering all possible configurations of packets and VPN tunnels, a cascade of relatively small logical group ID tables may appropriately select a VPN tunnel for a given packet.

Additionally, as will be apparent to a person skilled in the art, much of the mechanics of a packet moving through a PE router is expected to occur as is typical. Such aspects as forwarding a packet from an input line card to an output line card over a particular route through a switching fabric and maintaining packet order are well known.

Advantageously, aspects of the present invention take full advantage of the characteristics that are used by VRF tables to forward packets based on MPLS LSPs. Further advantageously, the size of VRF tables may be reduced while providing flexibility in managing VPNs and scalability in terms of the size and granularity of the forwarding routing tables.

As will be apparent to a person skilled in the art the hereinbefore described method may be equally applicable to Point-to-Point network applications and to Multi-cast network applications. That is, a given virtual private network tunnel that may be logically grouped and individually selected, may have a single end point or multiple end points.

Other modifications will be apparent to those skilled in the art and, therefore, the invention is defined in the claims.

We claim:

1. A method of forwarding a packet comprising:
determining a logical grouping of a plurality of virtual private network tunnels based on a classification criterion;
classifying a received packet based on said classification criterion; and
based on a result of said classifying, using a selection algorithm associated with said logical grouping to determine one of said plurality of virtual private network tunnels on which to forward said packet.

2. The method of claim 1 wherein said selection algorithm is a table look-up algorithm.

3. The method of claim 1 wherein said classifying said received packet comprises inspecting contents of said received packet.

4. The method of claim 1 further comprising:
determining a logical sub-grouping of said plurality of virtual private network tunnels based on a further classification criterion; and
further classifying said received packet based on said further classification criterion.

5. The method of claim 1 wherein said selection algorithm includes a traffic balancing algorithm.

6. The method of claim 1 wherein said virtual private network tunnels are defined as Multi Protocol Label Switching label switched paths.

7. The method of claim 6 wherein said received packet has includes destination address and said selection algorithm involves determining a label for a network element having said destination address.

8. A router operable to:
determine a logical grouping of a plurality of virtual private network tunnels based on a classification criterion;
classify a received packet based on said classification criterion; and
based on a result of said classifying, use a selection algorithm associated with said logical grouping to determine one of said plurality of virtual private network tunnels on which to forward said packet.

9. A computer readable medium containing computer-executable instructions which, when performed by processor in router, cause the processor to:
determine a logical grouping of a plurality of virtual private network tunnels based on a classification criterion;
classify a received packet based on said classification criterion; and
based on a result of said classifying, use a selection algorithm associated with said logical grouping to determine one of said plurality of virtual private network tunnels on which to forward said packet.

10. A method of forwarding a received packet in a virtual private network comprising:
associating a logical grouping of a plurality of virtual private network tunnels with a classification criterion;
inspecting said received packet for a characteristic meeting said classification criterion; and
if said received packet has said characteristic meeting said classification criterion, forwarding said received packet on one of said plurality of virtual private network tunnels.

11. The method of claim 10 further comprising, if said received packet has said characteristic meeting said classification criterion, modifying said received packet before said forwarding.

12. The method of claim 11 wherein said modifying comprises encapsulating said received packet.

13. A router operable to:
associate a logical grouping of a plurality of virtual private network tunnels with a classification criterion;
inspect said received packet for a characteristic meeting said classification criterion; and
if said received packet has said characteristic meeting said classification criterion, forward said received packet on one of said plurality of virtual private network tunnels.
